(19) United States
(12) Patent Application Publication
(10) Pub. No.: US 2026/0042879 A1
(43) Pub. Date: Feb. 12, 2026

(54) COMPOSITIONS AND METHODS FOR PREPARING SELF-CRUSHABLE VISCOELASTIC POLYURETHANE FOAM

(71) Applicant: Dow Global Technologies LLC, Midland, MI (US)

(72) Inventors: Degang Zhang, Shanghai (CN); Luca Lotti, Rubiera (IT)

(21) Appl. No.: 19/100,139

(22) PCT Filed: Aug. 5, 2022
(86) PCT No.: PCT/CN2022/110458

§ 371 Date: Jan. 31, 2025

(51) Int. Cl. C08G 18/40; C08G 18/18; C08G 18/42; C08G 18/48; C08G 18/76

(52) U.S. Cl. CPC C08G 18/4018; C08G 18/1808; C08G 18/425; C08G 18/4841; C08G 18/7664; C08G 2110/0083

(57) ABSTRACT

Polyurethane foam compositions include a reaction product of: an isocyanate component including one or more isocyanate compound, and an isocyanate-reactive component containing: an ethylene oxide-rich (EO-rich) polyether polyol at a percent by weight (wt %) of 10 wt % to 35 wt %; a propylene oxide-rich (PO-rich) polyether polyol at a percent by weight (wt %) of 30 wt % to 80 wt %; and a polyester polyol at a percent by weight (wt %) of 10 wt % to 35 wt %, polyester polyol based on reaction product of an aromatic diacid or alkyl diacid and a polyol having an OH functionality 2 to 4.

### FIELD

Embodiments relate to self-crushable viscoelastic polyurethane foam compositions. Particularly, viscoelastic polyurethane foams prepared from a polyol blend of one or more polyester polyols and polyether polyols.

### INTRODUCTION

Viscoelastic Polyurethane (VE) foam represents a fast growing segment of the polyurethane foam industry. VE foam is characterized in part by the slow recovery from compression. These properties distinguish VE foams from high resilience (HR) and “conventional” polyurethane flexible foams that have much greater resilience and recover almost immediately after compression. VE foams are used in a wide variety of applications, including use as memory foams and in acoustic damping applications to reduce NVH (noise, vibration and harshness).

Depending on the application, a number of polyurethane foam properties may be tuned for adequate performance, such as foam density, thickness, cell morphology, and the like. Preparation of VE foams often utilizes chemical techniques that modify the phase separation of the constituent polymer segments. For example, methods may include crosslinking to reduce the equivalent weight of the soft segment using mixtures of polyols of varying length. However, reduction of equivalent weight may also increase the rates of foam shrinkage and reduce the fraction of open cells. To counteract these affects, cells may be mechanically opened by crushing, but the additional treatments require specialized equipment and increases in time and production costs.

### SUMMARY

Embodiments disclosed herein include polyurethane foam compositions include a reaction product of: an isocyanate component including one or more isocyanate compound, and an isocyanate-reactive component containing: an ethylene oxide-rich (EO-rich) polyether polyol at a percent by weight (wt %) of 10 wt % to 35 wt %, wherein the EO-rich polyether polyol includes an EO-capped EO/PO polymer containing at least 70 wt % EO, an OH number in a range of 20 mg KOH/g to 50 mg KOH/g, and a primary OH content of at least 40% of the total OH groups; a propylene oxide-rich (PO-rich) polyether polyol at a percent by weight (wt %) of 30 wt % to 80 wt %, wherein the PO-rich polyether polyol contains an EO-capped EO/PO polymer containing at least 75 wt % PO, an OH number in a range of 20 mg KOH/g to 50 mg KOH/g, and a primary OH content of at least 50% of the total OH groups; and a polyester polyol at a percent by weight (wt %) of 10 wt % to 35 wt %, polyester polyol based on reaction product of an aromatic diacid or alkyl diacid and a polyol having an OH functionality 2 to 4, wherein the polyester polyol has an OH number in the range of 20 mg KOH/g to 100 mg KOH/g.

### DETAILED DESCRIPTION

Embodiments relate to self-crushable VE polyurethane foam compositions prepared from a polyol blend of one or more polyester polyols and polyether polyols. VE polyurethane foam compositions disclosed herein are regarded “self-crushing” in which produced foams require no post-production foam crushing step. Molded articles and foam compositions having a high damping factor are also disclosed.

VE polyurethane foam compositions may be prepared by reacting an isocyanate component with an isocyanate-reactive component. VE polyurethane foam compositions may be molded by transferring a reaction mixture to a closed mold, where the reaction generates a molded polyurethane foam. After demolding, the resulting foam does not require a post-form foam crushing step and does not exhibit foam shrinkage or collapse after foam rise.

Polyol blends may include a mixture of polypropylene oxide-rich (PO-rich) polyether polys and ethylene oxide-rich (EO-rich) polyether polyols that modify the mechanical and reactive properties of the blends. Particularly, PO-rich polyether polys may decrease reactivity within the polyurethane, increasing mechanical performance and resiliency. Moreover, the EO-rich polyether polyols are introduced to increase reactivity, while also promoting phase separation within the forming polyurethane foam. Phase separation promotes the cell connectivity within the forming foam, increasing air permeation during the blowing process thus reducing shrinkage. The special structure of polyester polyols, in particular the natural presence of hard segments in the form of an aromatic ring together with carboxyl groups, increases the existence of the hard segment in the final polymer, promoting the phase separation and also increasing the glass transition temperature of the final PU polymer. The result of the introduction of polyester polyols is a self-crushing viscoelastic polyurethane foam, having good vibration damping properties.

Produced polyurethane foam compositions may have a high open cell content and damping factor, without the requirement for additional crushing to mitigate excess foam shrinkage. Control of foam properties may include varying the ratio of soft and hard segments in isocyanate and isocyanate-reactive components, heat treatments, and processing conditions. Polyurethane foam compositions may have a density as determined by ASTM D-3574-17 ranging from 40 kg/m³ to 120 kg/m³, 40 kg/m³ to 100 kg/m³, or 50 kg/m³ to 90 kg/m³. Viscoelastic polyurethane foam compositions may have a damping factor determined by DIN 53426 of greater than 0.25, greater than 0.30, or greater than 0.35.

Viscoelastic polyurethane foams may have an isocyanate index, defined as the molar stoichiometric ratio of isocyanate moieties in a reaction mixture with respect to the number of moles of isocyanate-reactive units (active hydrogens available for reaction with the isocyanate moiety), multiplied by 100. An isocyanate index of 100 means that there is no stoichiometric excess, such that there is 1.0 mole of isocyanate groups per 1.0 mole of isocyanate-reactive groups, multiplied by 100. Isocyanate components may have an isocyanate index in a range of from 50 to 120, 60 to 100, or 70 to 90.

Viscoelastic polyurethane foam compositions disclosed herein may include multilayers structures containing a polyurethane foam coated on a substrate such as paper, metal, plastic, wood board, rubber, cotton fleece, and the like. Multilayer polyurethane foam compositions may be laminated. Polyurethane foams may be used in applications such as fillers in automobile interiors, exteriors, and structural components, acoustic applications and surfaces, and the like. Examples include automotive vehicle applications as bodies (frames), hoods, doors, fenders, instrument panels, mirror housings, bumpers, ornaments, carpet, and the like.

Viscoelastic polyurethane foams may be generated by reacting an isocyanate component with an isocyanate-reactive component containing a polyol blend. Isocyanate components can include at least one compound having an isocyanate group. The isocyanate component may include one or more isocyanates and polyisocyanates having an average of greater than 1.0 isocyanate groups per molecule. The isocyanate components may contain moieties that are aliphatic, cycloaliphatic, alicyclic, arylaliphatic, aromatic, and/or derivatives thereof. Examples of compounds suitable for use in isocyanate components include monomeric methylene diphenyl diisocyanate (MDI), modified MDI, oligomeric MDI, polymeric MDI, toluene 2,4-/2,6-diisocyanate (TDI), and the like.

Isocyanates may have an average isocyanate functionality from 1 to 5, 1.5 to 5, 2 to 5, or 3 to 5. The isocyanate can have an isocyanate equivalent weight (EW) in a range of 75 g/eq to 250 g/eq, 80 g/eq to 200 g/eq, or 80 to 175 g/eq. The isocyanate can have an isocyanate content based on a total weight of the isocyanate in a range of 20 wt % to 45 wt %, 25 wt % to 45 wt %, or 25 wt % to 40 wt %.

The isocyanate-reactive component may include a blend of polyols, including a polyester polyol and a mixture of EO-rich and PO-rich polyether polyols. Isocyanate-reactive components may include a polyol blend containing one or more polyester polyols at a percent by weight of the blend (wt %) in a range of 10 wt % and 35 wt %; one or more EO-rich polyether polyols in a range of 10 wt % and 35 wt %; and one or more PO-rich polyether polyol in a range of 30 wt % and 80 wt %.

The isocyanate-reactive component may include an EO-rich polyether polyol containing an EO-capped copolymer of ethylene oxide/propylene oxide (EO/PO) that includes a percent by weight (wt %) of EO of at least 70 wt %, at least 75 wt %, or at least 80 wt %. EO-rich polyether polyols may have an average hydroxyl number (OH number or OHv) as determined according to ASTM D4274-21 in a range of 20 mg KOH/g to 50 mg KOH/g, 25 mg KOH/g to 45 mg KOH/g, or 30 mg KOH/g to 40 mg KOH/g. EO-rich polyether polyols may have a polyol equivalent weight of 1100 to 2800, 1200 to 2500, or 1250 to 2250.

EO-rich polyether polyols may include a primary hydroxyl (primary OH) content as determined by ASTM D4273-18 of at least 40%, at least 50%, at least 70%, or at least 90%, including ranges from 40% to 95%. EO-rich polyether polyols may have a hydroxyl functionality of 3 or more.

The isocyanate-reactive component may include an PO-rich polyether polyol containing an EO-capped copolymer of ethylene oxide/propylene oxide (EO/PO) that includes a percent by weight (wt %) of PO of at least 75 wt %, at least 80 wt %, or at least 85 wt %. PO-rich polyether polyols may have an average hydroxyl number (OH number) as determined according to ASTM D4274-21 in a range of 20 mg KOH/g to 50 mg KOH/g, 25 mg KOH/g to 45 mg KOH/g, or 30 mg KOH/g to 40 mg KOH/g. PO-rich polyether polyols may have a polyol equivalent weight of 1100 to 2800, 1200 to 2500, or 1250 to 2250.

PO-rich polyether polyols may include a primary hydroxyl (primary OH) content as determined by ASTM D4273-18 of at least 50%, at least 55%, or at least 60%, including ranges from 50% to 90%. PO-rich polyether polyols may have a hydroxyl functionality in a range of 3 or more, including 3 to 7, or 3 to 6.

Polyester polyols disclosed herein include reaction products one or more carboxylic diacids and a polyol having a with OH functionality 2 to 4. Suitable carboxylic acids may include aromatic diacids or anhydrides and C4 to C8 aliphatic diacids. Suitable polyols for the formation of polyesters include one or more alkylene glycols or polyalkylene glycols having a hydroxy functionality of 2 to 4, such as ethylene glycol, 1,2- or 1,3-propylene glycol, 1,4-butanediol, 1,6-hexanediol, diethylene glycol, and the like. Example polyester polyols include polyesters of phthalic anhydride and diethylene glycol, and polyesters of a C4 to C8 diacid such as succinic acid or adipic acid and diethylene glycol.

Polyester polyols may have an average hydroxyl number (OH number) as determined according to ASTM D4274-21 in a range of 20 mg KOH/g to 100 mg KOH/g, 25 mg KOH/g to 95 mg KOH/g, or 30 mg KOH/g to 90 mg KOH/g. Polyester polyols may have a polyol equivalent weight 560 to 2800, 590 to 2300, or 620 to 1900.

The isocyanate-reactive component may also contain one or more additives including catalysts, blowing agents, surfactants, crosslinkers, plasticizers, fillers, smoke suppressants, fragrances, reinforcements, dyes, colorants, pigments, preservatives, odor masks, physical blowing agents, chemical blowing agents, flame retardants, internal mold release agents, biocides, antioxidants, UV stabilizers, antistatic agents, thixotropic agents, adhesion promoters, cell openers, and the like.

Isocyanate-reactive components may include one or more catalysts, including amines such as trimethylamine, triethylamine, N-methylmorpholine, N-ethylmorpholine, N,N-dimethylbenzylamine, N,N,N′,N′-tetramethyl-1,4-butanediamine, N,N-dimethylpiperazine, 1,4-diazobicyclo-2,2,2-octane, bis(2-dimethylaminoethyl)ether, morpholine, pentamethyldiethylenetriamine and the like; as well as so-called “low emissive” tertiary amine catalysts that contain one or more isocyanate-reactive groups such as N,N-dimethylethanolamine, 1,4-diazabicylo[2.2.2]octane-2-methanol, N-[2-[2-(dimethylamino) ethoxy]ethyl]-N-methyl-1,3-propanediamine, and the like.

Isocyanate-reactive components may include one or more blowing agents in amounts sufficient to provide the desired foam density. Blowing agents may include water and other aqueous fluids, but also hydrocarbons such as n-pentane, isopentane, cyclopentane or a related blend, hydrofluorocarbons including hydrofluoroolefins, and the like. Blowing agents may be included in any suitable amount, including in a range of parts per polyol (i.e., isocyante-reactive component) (pphp) such as 1.5 pphp to 6 pphp, or from 2 pphp to 5 pphp.

### EXAMPLES

The following examples are provided to illustrate the embodiments of the invention, but are not intended to limit the scope thereof. All parts and percentages are by weight unless otherwise indicated. Table 1, lists the materials used in the following examples:

TABLE 1
Compounds used in sample formulations

| Compound | Raw material | Description | Supplier |
|---|---|---|---|
| EO-rich | VORANOL ™ | EO capped EO/PO random copolymer with ≥70 | Dow |
| polyether polyol | 1447 | wt % EO, glycol-based, OH number 36 | |
| | | mg KOH/g, primary OH about 90% | |
| Polyester polyol 1 | Stepanol PDP-70 | Phthalic anhydride/diethylene glycol (DEG) | Stepan |
| | | polyester; OH number 66-74 mg KOH/g | |
| Polyester polyol 2 | Diexter-G 156T-63 | aliphatic acid/DEG polyester; OH number | Coim |
| | | 61-66 mg KOH/g | |
| PO-rich polyether | SPECFLEX ™ | EO capped EO/PO copolymer with 15 wt % | Dow |
| polyol 1 | NC632 | EO, f ≥ 4; OH number 34 mg KOH/g, | |
| | | primary OH about 80% | |
| PO-rich polyether | SPECFLEX ™ | EO capped EO/PO copolymer with 15 wt % | Dow |
| polyol 2 | NC138 | EO, f = 3, OH number 29 mg KOH/g, | |
| | | primary OH about 80% | |
| Comparative | VORANOL 446 | PO-based polyol, Glycerine and sucrose- | Dow |
| polyether polyol | | initiated, OH number 446 mg KOH/g | |
| Mold Release | ChemTrend PU- | Water-based wax/silicone mold release | Chem Trend |
| Agent | 64005W | agent | |
| Surfactant | Tegostab B8734 | Silicone surfactant | Evonik |
| | LF2 | | |
| Catalyst 1 | Dabco 33 LV | 33% triethylene diamine in dipropylene | Evonik |
| | | glycol | |
| Catalyst 2 | DC-5LE | Delayed action catalyst | Evonik |
| Blowing Agent | Water | Chemical Blowing Agent | |
| Isocyanate | ISONATE 143L | Isocyanate | Dow |

Damping factor is measured by vibrational experiments according to DIN 53426. During testing, a foam sample (50 mm×50 mm×25 mm) is secured by two aluminum plates (50 mm×50 mm×2 mm) and fixed to two accelerometers. The samples are then tested using a vibration sweep in the dominion of frequency, which is recorded by the accelerometers. Damping factor (n) is obtained from the response, in dB, of the relative difference measured by the accelerometers over the frequency vibration sweep. In particular, after identifying a response with a peak, one defines:
f₀ as the frequency of the peak (resonance frequency)
f₁ as the frequency at which the response is 3 dB lower than the peak, with f₁>f₀
f₂ as the frequency at which the response is 3 dB lower than the peak, with f₂<f₀

$$η = ( {f}_{1} - {f}_{2} ) / {f}_{0}$$

In general, a foam may be defined as viscoelastic when the damping factor is greater than 0.25.

### Example 1: Preparation of Polyurethane Foam Compositions

In this example, polyurethane sample formulations where weighed and components were mixed by high-speed mixer and placed into a mold (400 mm×400 mm×40 mm) at temperatures ranging from 50° C. to 70° C. Mold was closed after pouring of the reactive mixture on the bottom of the mold itself. Demolding times varied depending on the selected catalyst and catalyst concentrations; however, all the inventive examples (IS) and the comparative examples (CS) described in the present invention were demolded after 120 seconds from casting.

The observation that samples are self-crushable (that is, no shrinkage occurs) is carried out by preparing foam samples at a molded density of 65 kg/m³. Following demolding of the sample, shrinkage is calculated by measuring foam thickness change. Foam samples free of foam shrinkage were classified as “self-crushable.”

Furthermore, the collapsing of foams was tested using a foaming experiment carried out in a cup. The settle down of the foam itself from the highest point that the foam reaches during polymerization (maximum height around 20 cm) is recorded. If the decrease in height after the reaching of the highest point is higher than 5 cm, the foam is defined as a collapsed one. In general, collapsed foams are unsuitable for many applications, including forming molded parts. Results for comparative samples are shown in Table 2 and for inventive samples in Table 3. Compound are presented in wt %, unless otherwise indicated.

TABLE 2
Comparative sample (CS) formulations and testing results

| Compound | CS1 | CS2 | CS3 | CS4 | CS5 | CS6 | CS7 | CS8 |
|---|---|---|---|---|---|---|---|---|
| EO-rich Polyether Polyol | 20.0 | 30.0 | 0 | 0 | 20.0 | 0 | 30.0 | 0 |
| Polyester polyol 1 | — | — | — | 20.0 | — | — | — | — |
| Polyester polyol 2 | — | | 20.0 | — | — | — | 30.0 | 20 |
| PO-rich polyether polyol 1 | 74.5 | 64.5 | 74.5 | 74.5 | 54.5 | 94.5 | 34.5 | — |
| PO-rich polyether polyol 2 | — | — | — | — | — | — | — | 74.5 |
| Comparative polyether | — | — | — | — | 20.0 | — | — | — |
| polyol | | | | | | | | |
| Catalyst 1 | 1.0 | 1.0 | 1.0 | 1.0 | 1.0 | 1.0 | 1.0 | 1.0 |
| Catalyst 2 | 0.5 | 0.5 | 0.5 | 0.5 | 0.5 | 0.5 | 0.5 | 0.5 |
| Silicone surfactant | 0.5 | 0.5 | 0.5 | 0.5 | 0.5 | 0.5 | 0.5 | 0.5 |
| Blowing agent | 3.5 | 3.5 | 3.5 | 3.5 | 3.5 | 3.5 | 3.5 | 3.5 |
| Total Polyol | 100.0 | | | | | | | |
| ISONATE 143L (b) | NCO index: 80 | | | | | | | |
| Molded density (kg/m³) | 61.2 | 60.3 | 59.8 | 59.2 | 60.3 | 60.1 | 61.0 | 59.7 |
| Damping factor | 0.13 | 0.17 | 0.15 | 0.13 | 0.34 | 0.12 | 0.39 | 0.16 |
| Shrinkage | No | No | Yes | Yes | Yes | Yes | No | Yes |
| Collapse | No | No | No | No | Yes | No | Yes | No |

TABLE 3
Inventive sample (IS) formulations and testing results

| Compound | IS1 | IS2 | IS3 | IS4 | IS5 |
|---|---|---|---|---|---|
| EO-rich polyether polyol | 20.0 | 20.0 | 15.0 | 30.0 | 25.0 |
| Polyester polyol 1 | — | 20.0 | — | — | — |
| Polyester polyol 2 | 20.0 | — | 30.0 | 15.0 | 25.0 |
| PO-rich Polyether polyol 1 | 54.5 | 54.5 | 49.5 | 49.5 | 44.5 |
| Catalyst 1 | 1.0 | 1.0 | 1.0 | 1.0 | 1.0 |
| Catalyst 2 | 0.5 | 0.5 | 0.5 | 0.5 | 0.5 |
| Silicone surfactant | 0.5 | 0.5 | 0.5 | 0.5 | 0.5 |
| Blowing agent | 3.5 | 3.5 | 3.5 | 3.5 | 3.5 |
| Total Polyol | 100.0 | | | | |
| ISONATE 143L | NCO index: 80 | | | | |
| Molded Density (kg/m³) | 59.5 | 61.2 | 59.2 | 60.3 | 61.5 |
| Damping factor | 0.33 | 0.29 | 0.31 | 0.28 | 0.35 |
| Shrinkage | No | No | No | No | No |
| Collapse | No | No | No | No | No |

For CS1 and CS2, the absence of polyester polyol results in a low damping factor, even with the addition of the EO-rich polyether polyol: these foams are not viscoelastic. Formulations CS3 and CS4 exclude the EO-rich polyether polyol, with the result that the damping factor remains unacceptably low (also these foams are not viscoelastic) and the samples are not self-crushable. CS5 is a viscoelastic formulation that includes mixtures of EO-rich polyol and PO polyol that exhibits good damping properties, however, the lack of polyester polyol results in a foam with an unacceptably high shrinkage. CS6 exhibits good damping, but unacceptable shrinkage. CS7 is a polyol blend providing good damping properties, but unacceptable shrinkage. CS8 provides another example in which the exclusion of EO-rich polyol exhibits shrinkage and insufficient damping properties (the foam is not viscoelastic).

In contrast, IS1-IS5 provide a range of polyol blends meeting the desired damping factor of greater than 0.25, while also having acceptable shrinkage performance.

While the foregoing is directed to exemplary embodiments, other and further embodiments may be devised without departing from the basic scope thereof, and the scope thereof is determined by the claims that follow.

1. A polyurethane foam composition, comprising a reaction product of:
an isocyanate component including one or more isocyanate compound, and
an isocyanate-reactive component comprising:
i) an ethylene oxide-rich (EO-rich) polyether polyol at a percent by weight (wt %) of 10 wt % to 35 wt %, wherein the EO-rich polyether polyol comprises an EO-capped EO/PO polymer comprising at least 70 wt % EO, an OH number in a range of 20 mg KOH/g to 50 mg KOH/g, and a primary OH content of at least 40% of the total OH groups;
ii) a propylene oxide-rich (PO-rich) polyether polyol at a percent by weight (wt %) of 30 wt % to 80 wt %, wherein the PO-rich polyether polyol comprises an EO-capped EO/PO polymer comprising at least 75 wt % PO, an OH number in a range of 20 mg KOH/g to 50 mg KOH/g, and a primary OH content of at least 50% of the total OH groups; and
iii) a polyester polyol at a percent by weight (wt %) of 10 wt % to 35 wt %, polyester polyol based on reaction product of an aromatic diacid or alkyl diacid and a polyol having an OH functionality 2 to 4, wherein the polyester polyol has an OH number in the range of 20 mg KOH/g to 100 mg KOH/g.

2. The polyurethane foam composition of claim 1, wherein the polyurethane foam has a damping factor of at least 0.25 measured according to DIN 53426.

3. The polyurethane foam composition of claim 1, wherein the one or more isocyanate compounds comprise monomeric methylene diphenyl diisocyanate (MDI), modified MDI, oligomeric MDI, or polymeric MDI.

4. The polyurethane foam composition of claim 1, wherein the polyurethane foam has a density of 50 kg/m³ to 90 kg/m³.

5. The polyurethane foam composition of claim 1, wherein the isocyanate-reactive component further comprises water as a blowing agent.

6. The polyurethane foam composition of claim 1, wherein the isocyanate-reactive component further comprises an amine catalyst to the isocyanate-reactive component at a percent by weight in a range of 0.5 wt % to 15 wt %.

7. A molded article containing the polyurethane foam composition of claim 1.

8. A method of preparing the polyurethane foam composition of claim 1, comprising:
combining the isocyanate component and the isocyanate-reactive component to form a mixture;
processing the mixture in a mold to produce a molded foam article; and
demolding the molded foam article.
